(19) United States
(12) Patent Application Publication
(10) Pub. No.: US 2021/0122872 A1
(43) Pub. Date: Apr. 29, 2021

(54) FLAME-RESISTANT POLYURETHANE FOAM MATERIAL

(71) Applicants: Ruei-Hong HSU, Taoyuan City (TW); Jui-Cheng HSU, Taoyuan City (TW)

(72) Inventors: Ruei-Hong HSU, Taoyuan City (TW); Jui-Cheng HSU, Taoyuan City (TW)

(21) Appl. No.: 16/661,378

(22) Filed: Oct. 23, 2019

(51) Int. Cl. C08G 18/42; C08G 18/76; C08G 18/18; C08J 9/12; C08J 9/00; C08K 5/523

(52) U.S. Cl. CPC C08G 18/4213; C08G 18/7671; C08G 18/1825; C08J 2375/06; C08J 9/0038; C08K 5/523; C08J 2203/10; C08J 9/125

(57) ABSTRACT

A flame-resistant polyurethane foam material, including a polyurethane prepared by reacting an isocyanate with a polyester polyol, wherein the isocyanate has two or more isocyanate groups, and the polyester polyol has two or more hydroxyl groups and a terephthalic acid structure. The flame-resistant polyurethane foam material may further include a flame retardant which is a phosphate ester with a benzene structure; a foaming agent which is water or pentane; and a catalyst which is a tertiary amine or an organometallic compound. The flame-resistant polyurethane foam material has significantly improved flame resistance due to the polyurethane prepared by using the polyester polyol with a high content of terephthalic acid structure as raw material and due to using the phosphate ester with a benzene structure as a flame retardant.

### BACKGROUND OF THE INVENTION

### 1. Field of the Invention

The invention relates to a flame-resistant polyurethane foam material and, in particular, relates to a flame-resistant polyurethane foam material with a high content of terephthalic acid structure, which meets the requirement for high flame resistance.

### 2. The Prior Arts

Plastic products have the advantages of durability, light weight, low electrical conductivity, easy molding and low cost. Generally, plastic products have a density of about 0.9 to 1.5 g/cm³. To obtain weight-reduced plastic products with diversified structures, a foaming technique has been developed that introduces gas into a plastic matrix to form cellular plastics. In addition to the advantages of light weight and low cost, the cellular structure decreases the density of plastic foam products, and contributes to the characteristics including floating ability, sound insulation, thermal insulation and shock resistance. Therefore, the plastic foam products can be applied to diverse settings including thermal insulation building materials, traffic vehicles, and sports equipment.

Referring to FIG. 1, polyurethane (PU) (3) is a polymer with a main chain containing a repeated urethane structure (4). Said polymer is a copolymer obtained by addition polymerization of polyols (1) and isocyanates (2). Optionally, an appropriate amount of a foaming agent is added to the raw materials (e.g. polyols and isocyanates) for synthesizing polyurethane and mixed uniformly, and then the mixture is filled in a mold, where the polymerization reaction and the foaming occur to produce a flame-resistant polyurethane foam material. Different raw materials are used to synthesize rigid, soft or semi-rigid flame-resistant polyurethane foam materials. For example, when isocyanates with a high content of isocyanate groups (NCO—) is selected as the raw material, the chemical crosslinking ratio would increase, thereby yielding a flame-resistant polyurethane foam material with greater hardness. Conversely, when a soft polyether polyol is selected as the raw material, a flame-resistant polyurethane foam material with lower hardness is obtained.

Due to the advantages of light weight, less expense, thermal insulation, and sound insulation, the rigid flame-resistant polyurethane foam material is widely used in partition walls in buildings, corrugated sheets on roof, and the hulls and accessories of watercraft. However, in terms of buildings or transportation vehicles (such as watercraft), there are strict regulations on the flame resistance of materials constituting the buildings or watercraft due to safety concerns. This is to avoid casualty, property loss, and disaster aggravation resulted from the inflammableness of these materials.

Among the polyols used as one of the raw materials for synthesizing conventional flame-resistant polyurethane foam materials, most of the polyester polyols and polyether polyols contain no aromatic rings. Such flame-resistant polyurethane foam materials are insufficient in hardness, strength, and flame resistance to be applied in buildings and transportation vehicles, which require relatively high structural strength and safety.

Accordingly, a novel flame-resistant polyurethane foam material has been developed that uses polyester polyols having a benzene structure as raw materials, whose benzene structure comes from an ortho- or meta-phenyldimethanoic acid. Although the benzene structure increases the strength, hardness, and flame resistance of the flame-resistant polyurethane foam material to a certain level, such an asymmetric structure cannot sufficiently improve the strength, hardness and flame resistance to meet the high requirements for buildings and transportation vehicles.

Therefore, there is a need for a polyester polyol with a symmetrical structure as a raw material for synthesizing flame-resistant polyurethane foam materials, so as to produce a flame-resistant polyurethane foam material that meets the high product requirements.

### SUMMARY OF THE INVENTION

In view of the problems encountered in the prior art, the present invention is intended to provide a flame-resistant polyurethane foam material, wherein the polyester polyol used as the raw material for synthesizing the polyurethane has a para-phenyldimethanoic acid (terephthalic acid) structure, instead of an ortho-phenyldimethanoic acid (phthalic acid) structure or a meta-phenyldimethanoic acid (isophthalic acid) structure. Also, a phosphate ester with a benzene structure may be added as a flame retardant additive. Said polyester polyol and phosphate ester improve the flame resistance of the flame-resistant polyurethane foam material.

The present invention provides a flame-resistant polyurethane foam material, which includes a polyurethane prepared by reacting an isocyanate with a polyester polyol, wherein the isocyanate has two or more isocyanate groups, and the polyester polyol has two or more hydroxyl groups and has a high content of terephthalic acid structure.

In one embodiment of the present invention, the polyester polyol is prepared by a condensation polymerization reaction or an ester interchange reaction between terephthalic acid and a polyhydric alcohol.

In one embodiment of the present invention, the isocyanate has 28 to 34 wt % of the isocyanate group.

In one embodiment of the present invention, the polyester polyol has a hydroxyl value of 250 to 450 mg KOH/g.

In one embodiment of the present invention, the polyester polyol has a molecular weight of 300 to 3000 g/mol.

In one embodiment of the present invention, the molar ratio of the isocyanate group to the hydroxyl group is 1:0.9 to 1:1.1.

In one embodiment of the present invention, the flame-resistant polyurethane foam material further includes a flame retardant.

In one embodiment of the present invention, the flame retardant is a phosphate ester with a benzene structure.

In one embodiment of the present invention, the flame retardant is diphenyl phosphate or triphenyl phosphate.

In one embodiment of the present invention, the mass ratio of the flame retardant to the polyester polyol is 3:100 to 20:100.

In one embodiment of the present invention, the flame-resistant polyurethane foam material further includes a foaming agent.

In one embodiment of the present invention, the foaming agent is water or pentane.

In one embodiment of the present invention, the flame-resistant polyurethane foam material further includes a catalyst.

In one embodiment of the present invention, the catalyst is a tertiary amine or an organometallic compound.

In one embodiment of the present invention, the catalyst is dimethylethanolamine.

In one embodiment of the present invention, the flame-resistant polyurethane foam material further includes at least one additive selected from a surfactant, an ultraviolet absorber, a light stabilizer, a chain extender, a crosslinking agent, a colorant, and a filler.

In one embodiment of the present invention, a predetermined area of the flame-resistant polyurethane foam material burns for 3.2 seconds or less after exposure to a flame at 1000° C. for 30 minutes.

In one embodiment of the present invention, 10% or less of the flame-resistant polyurethane foam material is burned to ash after a predetermined area of the flame-resistant polyurethane foam material is exposed to a flame at 1000° C. for 30 minutes.

In one embodiment of the present invention, a predetermined area of the flame-resistant polyurethane foam material burns for 2 seconds or less after exposure to a flame at 1000° C. for 30 minutes.

In one embodiment of the present invention, 5% or less of the flame-resistant polyurethane foam material is burned to ash after a predetermined area of the flame-resistant polyurethane foam material is exposed to a flame at 1000° C. for 30 minutes.

The terephthalic acid has better structural symmetry than the phthalic acid and isophthalic acid. Therefore, compared with the conventional flame-resistant polyurethane foam materials, which are made of isocyanates and the polyester polyols having the phthalic acid or isophthalic acid structure, the flame-resistant polyurethane foam material of the present invention has higher structural strength, greater hardness, and better flame resistance, because it includes the polyurethane made of both isocyanates and the polyester polyols having a high content (35 to 70 wt %) of terephthalic acid structure, which provides the structural symmetry and rigidity of the benzene structure.

Furthermore, by replacing conventional phosphorus or silicon flame retardants with the flame retardants made of phosphate esters with a benzene structure, the flame-resistant polyurethane foam material of the present invention has more improved flame resistance.

In one embodiment of the present invention, water is a favorable foaming agent, since water is of low cost and easily available, and carbon dioxide, as a product of the foaming process, does not cause serious environmental pollution.

In another embodiment of the present invention, an appropriate catalyst can be selected for use to accelerate the foaming process and/or the polyurethane synthesis, depending on the product requirements for the flame-resistant polyurethane foam material.

Moreover, by addition of at least one additive such as surfactants, ultraviolet absorbers, light stabilizers, chain extenders, crosslinking agents, colorants and fillers, the flame-resistant polyurethane foam material can have various improved properties that meet specific product requirements.

As described above, because the flame-resistant polyurethane foam material of the present invention uses a polyester polyol with a high content (35 to 70 wt %) of terephthalic acid structure as one of the raw materials for synthesizing polyurethane, the flame resistance thereof significantly improves. Further, in the case where a phosphate ester with a benzene structure is further added as a flame retardant, the flame resistance of the flame-resistant polyurethane foam material can be further improved.

Therefore, after a predetermined area of the flame-resistant polyurethane foam material is exposed to a flame at 1000° C. for 30 minutes, the ignited flame does not spread, and the burning area is carbonized but without perforation. Thus, the flame-resistant polyurethane foam material of the present invention meets the flame retardant requirements for buildings and transportation vehicles.

### BRIEF DESCRIPTION OF THE DRAWINGS

The present invention will be apparent to those skilled in the art from the following detailed description of a preferred embodiment thereof, with reference to the accompanying drawings, in which:

FIG. 1 is a schematic diagram illustrating an addition polymerization reaction between a polyol and an isocyanate to synthesize a polyurethane;

FIG. 2 is a schematic diagram illustrating a condensation polymerization reaction between terephthalic acid and a polyhydric alcohol to synthesize a polyester polyol with a terephthalic acid structure;

FIG. 3 is a schematic diagram of the phthalic acid structure;

FIG. 4 is a schematic diagram of the isophthalic acid structure;

FIG. 5 is a schematic diagram of the reaction between an isocyanate group and water to form carbon dioxide; and

FIG. 6 is a flow chart depicting the synthesis of a flame-resistant polyurethane foam material of the present invention.

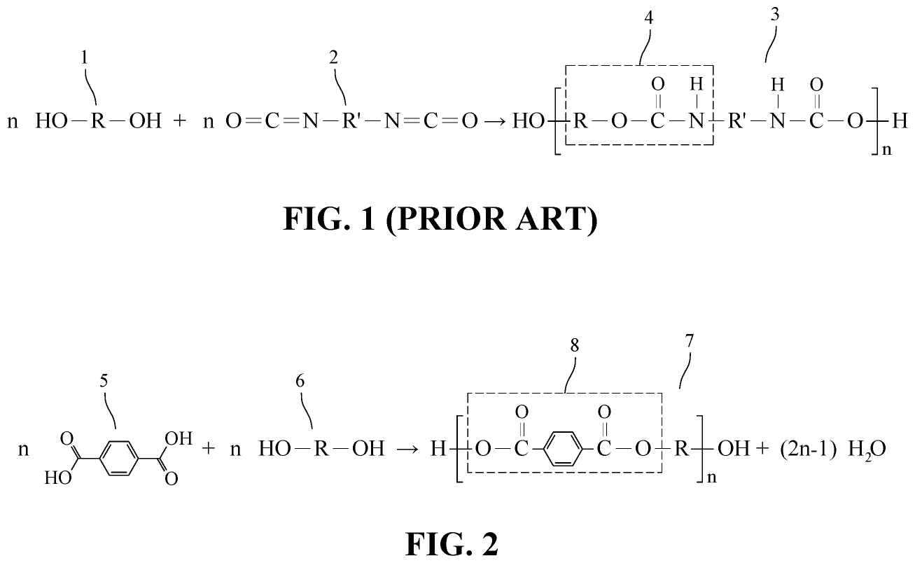

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

The present invention provides a flame-resistant polyurethane foam material, wherein the polyester polyol used as the raw material for synthesizing the polyurethane has a para-phenyldimethanoic acid (terephthalic acid) structure, instead of an ortho-phenyldimethanoic acid (phthalic acid) structure or a meta-phenyldimethanoic acid (isophthalic acid) structure. The use of polyester polyol with a terephthalic acid structure improves the flame resistance of the flame-resistant polyurethane foam material.

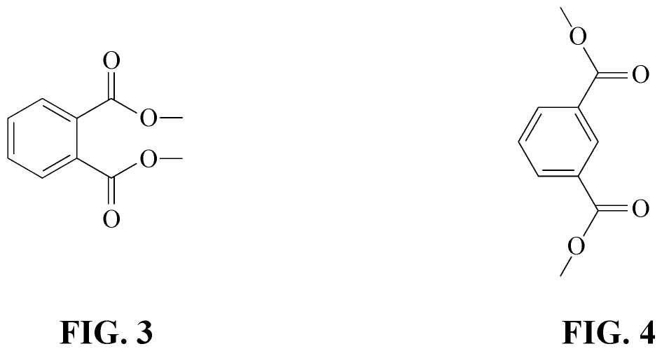

Referring to FIG. 2 to FIG. 4, a para-phenyldimethanoic acid structure (8) or a terephthalic acid structure (8) as used herein refers to a benzene structure with two carboxyl groups in para position; an ortho-phenyldimethanoic acid structure or a phthalic acid structure refers to a benzene structure with two carboxyl groups in ortho position; and a meta-phenyldimethanoic acid structure or an isophthalic acid structure refers to a benzene structure with two carboxyl groups in meta position.

Moreover, a phosphate ester with a benzene structure may be added as a flame retardant additive to further improve the flame resistance of the flame-resistant polyurethane foam material, so that the flame-resistant polyurethane foam material of the present invention can meet the higher requirement of strength, hardness and combustion characteristics.

### First Embodiment

In the first embodiment of the present invention, the flame-resistant polyurethane foam material is a polyurethane, which serves the matrix of the flame-resistant polyurethane foam material. The polyurethane is a copolymer synthesized by an addition polymerization reaction, in which an isocyanate and a polyester polyol are the monomers to be polymerized. Optionally, the isocyanate and the polyester polyol are mixed with vigorous mechanical stirring to assist the foaming of the polyurethane matrix, thereby producing the flame-resistant polyurethane foam material.

Generally, polyurethanes are synthesized by using both isocyanates with two or more isocyanate groups and polyester or polyether polyols with two or more hydroxyl groups. The polyester polyols are polyester compounds obtained by a condensation polymerization reaction or an ester interchange reaction between a polybasic acid with two or more carboxyl groups and a polyhydric alcohol with two or more hydroxyl groups. The polyether polyols are polyether compounds obtained by a ring-opening polymerization reaction of an epoxy olefin using an initiator containing active hydrogen.

In all embodiments of the present invention, the symmetrical structure of terephthalic acid is required to improve the structural strength, hardness, and flame resistance of the flame-resistant polyurethane foam material. Therefore, an isocyanate and a polyester polyol with a high content of terephthalic acid structure are used to synthesize the polyurethane.

Referring to FIG. 2, in one embodiment of the present invention, the polyester polyol (7) is prepared by a condensation polymerization reaction between a polybasic acid and a polyhydric alcohol (6), and the polybasic acid is exemplified by terephthalic acid (5). That is, the polyester polyol is prepared by the condensation polymerization reaction between terephthalic acid and a polyhydric alcohol, so that the polyester polyol has a terephthalic acid structure (8).

Given that the terephthalic acid has two carboxyl groups, and the polyhydric alcohol has two or more hydroxyl groups, the two compounds can polymerize through condensation between their respective carboxyl groups and hydroxyl groups to produce a copolymer with terephthalic acids and polyhydric alcohols being monomers. The copolymer is thus a polyester polyol with a high content of terephthalic acid structure.

Specifically, the polyhydric alcohol may be, but no limited to, ethylene glycol (EG), dipropylene glycol (DPG), 1,4-butanediol (BDO), diethylethylene glycol (DEG), glycerol, or trimethylolpropane (TMP).

Preferably, the polyester polyol has a hydroxyl value of 250 to 450 mg KOH/g, that is, the amount of hydroxyl group (—OH) in 1 g of the polyester polyol is equivalent to 250 to 450 mg of potassium hydroxide (KOH).

Preferably, the polyester polyol has a molecular weight of 300 to 3000 g/mol, that is, the molecular weight of the polyester polyol ranges between 300 g/mol and 3000 g/mol, including the endpoints of the given range.

The isocyanate has two or more isocyanate groups, and the polyester polyol has two or more hydroxyl groups. Therefore, the isocyanate and the polyester polyol can undergo addition polymerization through their respective isocyanate groups and hydroxyl groups to synthesize a copolymer (i.e., polyurethane) with isocyanate and polyester polyol being monomers.

Preferably, the isocyanate may be methylene diphenyl diisocyanate (MDI) or tolylene diisocyanate (TDI).

Preferably, the content of the isocyanate group (% NCO) of the isocyanate is 28 to 34 wt %, that is, 28 to 34 g of isocyanate group (—NCO) is present in 100 g of the isocyanate.

Alternatively, the isocyanate may be, but not limited to, other aromatic isocyanates such as hexamethylene diisocyanate (HDI), methylene diphenyl diisocyanate (MDI), p-phenylene diisocyanate (PPDI), naphthalene diisocyanate (NDI), dimethylbiphenyl diisocyanate (TODI), or polymethylene polyphenyl isocyanate (PAPI).

Alternatively, the isocyanate may be, but not limited to, aliphatic isocyanates such as 1,6-hexamethylene diisocyanate (HDI), isophorone diisocyanate (IPDI), 4,4′-diisocyanato dicyclohexylmethane (H₁₂MDI), cyclohexane diisocyanate (CHDI), tetramethylxylene diisocyanate (TMXDI), or 1,3-bis(isocyanatomethyl) cyclohexane (H₆XDI).

In general, aromatic isocyanates are less expensive and have highly reactive isocyanate groups. Therefore, aromatic isocyanates are often used as raw materials for synthesizing polyurethanes. However, when polyurethane products with special requirements, for example, elastomers or products with excellent light stability, are requested, aliphatic isocyanates are chosen to synthesize the polyurethane. Therefore, the type of isocyanates is adjustable depending on product requirements.

In the first embodiment, the raw materials for synthesizing the polyurethane include a component A and a component B, wherein the component A includes a polyester polyol with a terephthalic acid structure; and the component B includes an isocyanate.

Referring to FIG. 6, in the polyurethane synthesis process, the component A is first preheated to a predetermined temperature (e.g., 20 to 60° C.) and stirred uniformly, and the component B is preheated to a predetermined temperature (e.g., 20 to 60° C.) and stirred uniformly. Next, the component B is rapidly added to the component A that is kept stirred, and the mixture of the component A and component B is stirred continuously at a predetermined temperature (e.g., 20 to 60° C.) for a predetermined time (e.g., 30 minutes) for thorough mixing.

Preferably, the feed ratio of the component B to the component A is adjusted so that the molar ratio of the isocyanate groups of the isocyanate, in the component B, to the hydroxyl groups of the polyester polyol, in the component A, is 1:0.9 to 1:1.1. Preferably, the mixture of the component A and component B is stirred at 20 to 60° C. for about 30 minutes till sufficiently uniform.

The uniform mixture of the component A and component B is then filled in a mold, where the polyester polyol in the component A and the isocyanate in the component B undergo addition polymerization during molding to produce the flame-resistant polyurethane material.

Since the component A and component B are mixed with vigorous mechanical stirring during the mixing process, the air is introduced into the mixture to form bubbles, which is so-called mechanical foaming. After the mixture of the component A and component B is filled in the mold and the addition polymerization reaction is completed, the air which is introduced into the mixture by mechanical foaming forms foam bubbles in the polyurethane matrix, which results in high-density microcellular foam. Therefore, the raw materials for polyurethane synthesis can be mechanically foamed simply by mechanical stirring, thereby producing the flame-resistant polyurethane foam material.

The terephthalic acid has better structural symmetry than the phthalic acid and isophthalic acid. Therefore, compared with the conventional flame-resistant polyurethane foam materials, which are made of isocyanates and the polyester polyols having phthalic acid structure or isophthalic acid structure, the flame-resistant polyurethane foam material of the present invention has higher structural strength, greater hardness, and better flame resistance, because it includes the polyurethane made of both isocyanates and the polyester polyols having a high content of terephthalic acid structure, which provides the structural symmetry and rigidity of the benzene structure.

### Second Embodiment

The second embodiment of the present invention is based on the first embodiment. The isocyanate and the polyester polyol used in the second embodiment are substantially the same as those used in the first embodiment.

In comparison to the first embodiment, the component A in the second embodiment further includes a flame retardant to enhance the flame resistance of the flame-resistant polyurethane foam material.

The flame retardant may be, but no limited to, a halogen flame retardant, a non-halogen inorganic flame retardant, or a non-halogen organic flame retardant.

The halogen flame retardant may be, but no limited to, a bromine flame retardant such as decabromodiphenyl oxide (DBDPO) or decabromodiphenyl ethane (DBDPE); a chlorine flame retardant such as Dechlorane plus or chlorinated paraffin; or a halogen-containing phosphorus flame retardant such as halogen-containing phosphate ester.

The non-halogen inorganic flame retardant may be, but no limited to, a metal hydroxide such as Al(OH)₃ or Mg(OH)₂; a phosphorus flame retardant such as red phosphorus or ammonium polyphosphate (APP); an ammonia flame retardant such as ammonia phosphate or ammonia carbonate; or other inorganic flame retardants such as molybdenum compounds, zinc borate, or zinc stannate.

The non-halogen organic flame retardant may be, but no limited to, a phosphorus flame retardant such as a phosphate ester, a phosphorus-containing polyol, or a phosphorus-containing ammonia compound; a silicon flame retardant such as a silicon compound; or a nitrogen flame retardant such as a triazine compound, melamine cyanurate, or a guanidine compound.

Preferably, the flame retardant may be a phosphate ester with benzene rings, such as diphenyl phosphate or triphenyl phosphate.

In the process of burning the flame-resistant polyurethane foam material, benzene free radicals are generated due to the benzene rings in diphenyl phosphate or triphenyl phosphate to capture hydrogen radicals and oxygen free radicals, thereby inhibiting the combustion chain reaction. Therefore, the flame resistance of the flame-resistant polyurethane foam material can be further improved once the conventional phosphorus or silicon flame retardant is replaced with the phosphate ester flame retardant including a benzene structure.

In the second embodiment, the raw materials for synthesizing the polyurethane include a component A and a component B, wherein the component A includes a polyester polyol with a terephthalic acid structure and a flame retardant; and the component B includes an isocyanate.

Referring to FIG. 6, in the polyurethane synthesis process, the component A, which includes a polyester polyol and a flame retardant, is first preheated to a predetermined temperature (e.g., 20 to 60° C.) and stirred uniformly, and the component B, which includes an isocyanate, is preheated to a predetermined temperature (e.g., 20 to 60° C.) and stirred uniformly. Next, the component B is rapidly added to the component A that is kept stirred, and the mixture of the component A and component B is stirred continuously at a predetermined temperature (e.g., 20 to 60° C.) for a predetermined time (e.g., 30 minutes) for thorough mixing.

Preferably, the mass ratio of the flame retardant to the polyester polyol in the component A can be adjusted between 3:100 and 20:100, that is, the content of the flame retardant in the component A is 3 to 20 phr (parts per hundred parts of resin, that is, the weight (g) of the flame retardant added to 100 g of polyester polyol).

Preferably, the feed ratio of the component B to the component A is adjusted so that the molar ratio of the isocyanate groups of the isocyanate, in the component B, to the hydroxyl groups of the polyester polyol, in the component A, is 1:0.9 to 1:1.1. Preferably, the mixture of the component A and component B is stirred at 20 to 60° C. for about 30 minutes till sufficiently uniform.

In the second embodiment, both the polymerization reaction for polyurethane synthesis and the mechanical foaming process are substantially the same as those in the first embodiment.

### Third Embodiment

The third embodiment of the present invention is based on the second embodiment. The isocyanate, the polyester polyol, and the flame retardant used in the third embodiment are substantially the same as those used in the second embodiment.

In comparison to the second embodiment, the component A in the third embodiment further includes a foaming agent to diversify the structure of the flame-resistant polyurethane foam material.

In the first and the second embodiments, the polyurethane matrix is mechanically foamed by mechanical stirring, so that the formed microcellular bubbles are small in size. A foaming agent can be further added during the synthesis of the polyurethane to expand the volume of the microcellular bubbles, thereby further reducing the density of the flame-resistant polyurethane foam material, so as to broaden the application of such material.

In general, gas can be generated in the polymer matrix by adding a foaming agent during the synthesis of the polymer. The generated gas increases the volume of the microcellular air bubble formed during the mechanical foaming process, thereby further reducing the density of the polymer product, so as to broaden the product uses.

The foaming method is typically classified into a mechanical foaming method, a physical foaming method, and a chemical foaming method.

For the mechanical foaming method, vigorous mechanical agitation is applied to introduce air into the polymer matrix to form microcellular air bubbles.

For the physical foaming method, a liquid with a low boiling point or high volatility, or an inert gas which is pressurized into a liquid can be used as a physical foaming agent. When the physical foaming agent is added to and mixed uniformly with the raw materials for synthesizing the polymer, the physical foaming agent will absorb heat and vaporize during the exothermic polymerization reaction, so that the resulted vapor increases the volume of the microcellular air bubbles in the polymer matrix.

For the chemical foaming method, a substance which generates gas by thermal decomposition or reaction with the raw materials for synthesizing a polymer or the synthesized polymer can be used as a chemical foaming agent. When the chemical foaming agent is added to and mixed uniformly with the raw materials for synthesizing the polymer, the chemical foaming agent will absorb heat during the exothermic polymerization reaction and decompose or react with the raw materials or the synthesized polymer to generate gas. Alternatively, the raw materials for synthesizing the polymer generate gas during the polymerization process, so that the generated gas increases the volume of microcellular air bubbles in the polymer matrix.

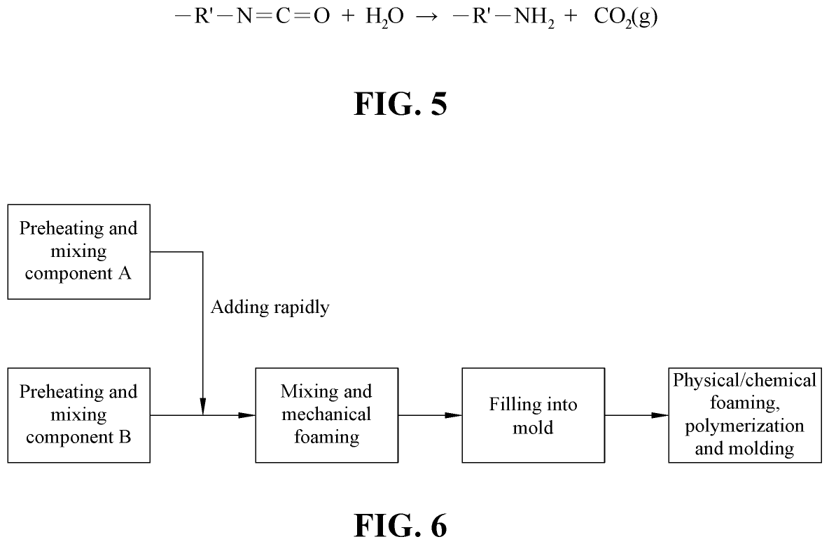

In the third embodiment, water is preferably added as a chemical foaming agent to further increase the volume of microcellular air bubbles in the polymer matrix, thereby further reducing the density of the flame-resistant polyurethane foam material. This is because water can reacts with the isocyanate groups of the isocyanate, which is one of the raw materials for synthesizing the polyurethane, to generate carbon dioxide gas (referring to FIG. 5).

Alternatively, a physical foaming agent may be used. The physical foaming agent includes, but not limited to, a liquid inert gas such as liquid carbon dioxide; an aliphatic hydrocarbon such as n-butane, isobutane, cyclopentane, neopentane, 2-methylpentane, n-hexane, 2-methylhexane, or n-heptane; an aromatic hydrocarbon such as benzene or toluene; or a halogenated hydrocarbon such as chlorofluorocarbons (CFCs, also called Freons).

Preferably, pentane is used as a physical foaming agent.

The Freons may be, but not limited to, hydrogenated hydrochlorofluorocarbons (HCFCs) such as HCFC-141b, HCFC-22, or HCFC-124; or hydrofluorocarbons (HFCs) such as HFC-245a or HFC-134a.

Alternatively, other chemical foaming agents may be used, including but not limited to azodicarbonamide (ADC), N, N′-dinitrosopentamethylenetetramine (DPT), or 4,4′-oxydibenzenesulfonyl hydrazide (OBSH).

In the third embodiment, the raw materials for synthesizing the polyurethane include a component A and a component B, wherein the component A includes a polyester polyol with a terephthalic acid structure, a flame retardant, and a foaming agent; and the component B includes an isocyanate.

Referring to FIG. 6, in the polyurethane synthesis process, the component A, which includes a polyester polyol, a flame retardant, and a foaming agent, is first preheated to a predetermined temperature (e.g., 20 to 60° C.) and stirred uniformly, and the component B, which includes an isocyanate, is preheated to a predetermined temperature (e.g., 20 to 60° C.) and stirred uniformly. Next, the component B is rapidly added to the component A that is kept stirred, and the mixture of the component A and component B is stirred continuously at a predetermined temperature (e.g., 20 to 60° C.) for a predetermined time (e.g., 30 minutes) for thorough mixing.

The feed ratio of the isocyanate, the polyester polyol, and the flame retardant in the third embodiment is substantially the same as that in the second embodiment.

The uniform mixture of the component A and component B is then filled in a mold, where the foaming agent (i.e., water) in the component A reacts with the isocyanate groups of the isocyanate in the component B to generate carbon dioxide gas through a chemical foaming process. Meanwhile, the polyester polyol in the component A and the isocyanate in the component B undergo addition polymerization during molding to obtain the flame-resistant polyurethane foam material.

The carbon dioxide gas generated by the chemical foaming process further increases the volume of the microcellular air bubbles generated during the mechanical foaming process. Therefore, after the mixture of the component A and component B is filled in the mold and the addition polymerization reaction and the foaming process are completed, microcellular foam with a relatively low density can be formed in the synthetic polyurethane matrix by the mechanical and chemical foaming process, thereby producing the flame-resistant polyurethane foam material with wide applications.

Since water is of low cost and easily available and carbon dioxide, as a product of the chemical foaming process, does not cause serious environmental pollution, water is a favorable foaming agent in this embodiment.

### Fourth Embodiment

The fourth embodiment of the present invention is based on the third embodiment. The isocyanate, the polyester polyol, the flame retardant, and the foaming agent used in the fourth embodiment are substantially the same as those used in the third embodiment.

In comparison to the third embodiment, the component A in the fourth embodiment further includes a catalyst to accelerate the chemical foaming process or the polyurethane synthesis process.

In general, in the manufacturing process of flame-resistant polyurethane foam materials, tertiary amines or organometallic compounds are used as catalysts. The tertiary amines can catalyze the reaction between the isocyanate groups and water, thereby accelerating the chemical foaming process. The organometallic compounds can catalyze the addition polymerization of the isocyanates and the polyester polyols, thereby increasing the polyurethane synthesis rate.

The tertiary amine catalyst may be, for example, but not limited to, dim ethyl ethanol amine (DMEA), dimethylcyclohexylamine (DMCHA), tetramethylbutanediamine (TMBDA), triethylamine (TEA), or triethylenediamine (TEDA).

The organometallic compound catalyst may be, for example, but not limited to, dibutyltin dilaurate (DBTDL), dibutyltin di-2-ethylhexanoate, tin octoate, potassium octoate, bismuth octoate, or potassium acetate.

In the embodiment of the present invention, the catalyst may preferably be dimethyl ethanol amine.

In the fourth embodiment, the raw materials for synthesizing the polyurethane include a component A and a component B, wherein the component A includes a polyester polyol with a terephthalic acid structure, a flame retardant, a foaming agent, and a catalyst; and the component B includes an isocyanate.

Referring to FIG. 6, in the polyurethane synthesis process, the component A, which includes a polyester polyol, a flame retardant, a foaming agent and a catalyst, is first preheated to a predetermined temperature (e.g., 20 to 60° C.) and stirred uniformly, and the component B, which includes an isocyanate, is preheated to a predetermined temperature (e.g., 20 to 60° C.) and stirred uniformly. Next, the component B is rapidly added to the component A that is kept stirred, and the mixture of the component A and component B is stirred continuously at a predetermined temperature (e.g., 20 to 60° C.) for a predetermined time (e.g., 30 minutes) for thorough mixing.

The feed ratio of the isocyanate, the polyester polyol, the flame retardant, and the foaming agent in the fourth embodiment is substantially the same as that in the third embodiment. Also, the polyurethane synthesis, the foaming processes, and the molding process in the fourth embodiment are substantially the same as those in the third embodiment.

Preferably, an appropriate catalyst can be selected for use to accelerate the foaming process and/or the polyurethane synthesis, depending on the product requirements for the flame-resistant polyurethane foam material.

### Fifth Embodiment

The fifth embodiment of the present invention is based on the fourth embodiment. The isocyanate, the polyester polyol, the flame retardant, the foaming agent, and the catalyst used in the fifth embodiment are substantially the same as those used in the fourth embodiment.

In comparison to the fourth embodiment, the component A in the fifth embodiment further includes at least one agent selected from a surfactant, an ultraviolet absorber, a light stabilizer, a chain extender, a crosslinking agent, a colorant, and a filler to meet the product requirements for the flame-resistant polyurethane foam material.

In general, among the raw materials for synthesizing the flame-resistant polyurethane foam material, the most essential ones are the isocyanate and the polyester polyol, serving as the monomers for polymerization. The foaming agent and the catalyst are also relatively important additives. In addition, other types of additives can be further added depending on the product requirements for the flame-resistant polyurethane foam material.

In one embodiment, a surfactant may be further added to the component A, and the surfactant may be, for example, a silicone oil or an organic siloxane. Since the surfactant is amphiphilic, it can promote the emulsification of the liquid component. In addition, the surfactant is used to regulate the surface tension of the liquid component and the interfacial tension between the liquid component and the gas in the microcellular bubbles. Therefore, the size of the microcellular bubble can be adjusted and the structure of the microcellular bubble can be stabilized, so as to avoid surface defects of the flame-resistant polyurethane foam material or collapse of the microcellular bubbles.

Alternatively, an ultraviolet absorber and/or a light stabilizer may be further added to the component A. When the polyurethane includes benzene rings, for example, a polyurethane synthesized from an aromatic isocyanate and a polyester polyol, the polyurethane turns yellow after exposure to ultraviolet radiation, resulting in a change in the appearance of the polyurethane product. Moreover, the polyurethane product may also degrade after exposure to ultraviolet radiation, resulting in a decrease in mechanical strength and reduced service life of the polyurethane product. The presence of the ultraviolet absorber can extend the service life of the flame-resistant polyurethane foam material since the ultraviolet absorber absorbs ultraviolet radiation and thus retard deterioration of the flame-resistant polyurethane foam material.

The ultraviolet absorber may be benzotriazoles, benzophenones or triazines.

The light stabilizers can be classified into single-molecule type, polymeric type, and low-alkaline type. By quenching the free radicals generated in the flame-resistant polyurethane foam material irradiated with ultraviolet light, the light stabilizers prevent the flame-resistant polyurethane foam material from continuous deterioration, thereby extending the service life of the flame-resistant polyurethane foam material.

In one embodiment, the ultraviolet absorber and the light stabilizer can be used simultaneously to further extend the service life of the flame-resistant polyurethane foam material.

Further, a chain extender and/or a crosslinking agent may be further added to the component A. The chain extender is a small-molecule amine or alcohol having two functional groups capable of reacting with the polyurethane and thus can react with the polyurethane to extend the polyurethane chain. The crosslinking agent is a small-molecule amine or alcohol having three or more functional groups capable of reacting with the polyurethane and thus can react with the polyurethane to both extend the polyurethane chain and increase number of crosslinking points.

Common chain extenders include diols or diamines, for example, 1,4-butanediol (BDO), hexanediol, hydroquinone bis(2-hydroxyethyl) ether (HQEE), bishydroxyethoxybenzene (HER), 3,3′-dichloro-4,4′-diphenylmethane diamine (MOCA), 3′-dichloro-polydiamine-4,4′-diphenylmethane diamine, biphenyldiamine, or triazine diamine.

Common crosslinking agents can be polyols or allyl polyol ethers such as glycerol, trimethylolpropane, 1,2,6-hexanetriol, pentaerythritol, or alpha-allyl glycerol ether (α-Age).

The addition of the chain extender and/or the crosslinking agent can regulate the mechanical strength, stretchability, tear resistance, and crystallization properties of the flame-resistant polyurethane foam material via chain extension reaction or crosslinking reaction. In addition, the flame-resistant polyurethane foam material can also obtain special properties such as thermal conductivity and chemical resistance by introducing the chain extender and/or the crosslinking agent with specific functional groups.

Further, depending on color requirements for the flame-resistant polyurethane foam products, a colorant may be further added to the component A, so that the flame-resistant polyurethane foam material is tinted in various colors.

In addition, a solid filler such as vermiculite or hollow micro beads may be further added to the component A, so as to enhance the impact resistance of the flame-resistant polyurethane foam material.

The feed ratio of the isocyanate, the polyester polyol, the flame retardant, the foaming agent, and the catalysts, and the process of mixing the component A and component B in the fifth embodiment are substantially the same as those in the fourth embodiment. Also, the polyurethane synthesis, the foaming processes, and the molding process in the fifth embodiment are substantially the same as those in the fourth embodiment.

By addition of at least one of the abovementioned additives, the flame-resistant polyurethane foam material can have various improved properties that meet specific product requirements.

### Flame Resistance Performance Test

In general, in order to certify whether flame-resistant polyurethane foam materials meet the safety requirements for buildings or transportation vehicles, flame resistance level for the relevant material has to be reported. Therefore, a flame resistance performance test (also referred to as burning test), modified according to the standard “BS 476-6:1989+A1:2009, Fire Tests on Building Materials and Structures, Part 6: Method of Test for Fire Propagation for Products”, was carried out on the flame-resistant polyurethane foam materials disclosed herein and those commercially available. In the flame resistance performance test, a predetermined area of the flame-resistant polyurethane foam material is burned for 30 minutes with a burner such as a high temperature flame gun reaching a temperature of 1000° C. to 1200° C., followed by an observation of whether the material is burned to ash, an examination of whether flame spreads beyond the predetermined area, and measurement of the flame extinction time after the burner is removed. The test results are shown in Table 1.

TABLE 1
Results of the burning test at 1000° C. on different flame-resistant polyurethane
foam materials

| | Polyester | Commercially | | | | |
|---|---|---|---|---|---|---|
| | polyol of the | available | | Triphenyl | | Continuous |
| | present | polyester | Isocyanate | phosphate | Burning test | burning |
| Example | invention (g) | polyol (g) | (g) | (g) | result | time |
| 1 | 0 | 72 | 100 | 0 | 100% burned | continuous |
| | | | | | to ash | burning |
| | | | | | (the fire | |
| | | | | | spreads) | |
| 2 | 0 | 72 | 100 | 7 | 85% burned | 6 seconds |
| | | | | | to ash | |
| | | | | | (the fire | |
| | | | | | spreads) | |
| 3 | 0 | 72 | 100 | 15 | 70% burned | 4.8 seconds |
| | | | | | to ash | |
| | | | | | (the fire | |
| | | | | | spreads) | |
| 4 | 100 | 0 | 100 | 0 | 10% burned | 3.2 seconds |
| | | | | | to ash | |
| | | | | | (the fire | |
| | | | | | spreads) | |
| 5 | 100 | 0 | 100 | 7 | 5% burned | 2 seconds |
| | | | | | to ash | |
| | | | | | (the fire | |
| | | | | | spreads) | |
| 6 | 100 | 0 | 100 | 15 | 5% burned | 1.9 seconds |
| | | | | | to ash | |
| | | | | | (the fire | |
| | | | | | spreads) | |

Referring to Table 1, examples 1 to 3 (comparative examples) are the flame-resistant polyurethane foam materials synthesized from an isocyanate and a commercially available polyester polyol having no terephthalic acid structure. Each of examples 2 and 3 further includes a flame retardant with a benzene structure. Examples 4 to 6 (embodiment examples) are the flame-resistant polyurethane foam materials synthesized from an isocyanate and the polyester polyol disclosed herein that has a high content (35 to 70 wt %) of terephthalic acid structure. Each of examples 5 and 6 further includes a flame retardant with a benzene structure.

The components of the comparative examples and embodiment examples listed in Table 1 are described in detail below.

(a) The polyester polyol of the present invention is synthesized from terephthalic acid and a polyhydric alcohol (such as ethylene glycol, glycerol, or butanediol), and has a hydroxyl value of 390 mg KOH/g and a molecular weight of 300 to 3000 g/mol.

(b) The commercially available polyester polyol, which is a polyester polyol without a terephthalic acid structure, is synthesized from a polybasic acid or an anhydride (such as succinic acid, adipic acid, or phthalic anhydride) without a terephthalic acid structure and a polyhydric alcohol (such as ethylene glycol, glycerol, or butanediol), and has a hydroxyl value of 280 mg KOH/g and a molecular weight of 800 to 10000 g/mol.

(c) The isocyanate is an isocyanate mixture mainly composed of diphenylmethane diisocyanate (MDI). The content of the isocyanate group of the isocyanate is 28 to 34 wt %.

Further, each of examples 1 to 6 listed in Table 1 is synthesized with the following additives:

(d) a triphenyl phosphate as a flame retardant with a benzene structure (the information regarding addition is given in Table 1);

(e) 1.5 g of water as a foaming agent; and

(f) 2 g of dimethylethanolamine as a catalyst.

For the polyester polyol of the present invention, the content of terephthalic acid structure is 35 to 70 wt %, that is, 35 to 70 g of the terephthalic acid structure (the structure (8) shown in FIG. 2) is present in 100 g of the polyester polyol.

Further, though 100 g of isocyanate was used for the synthesis of either one of examples 1 to 6, 72 g of the commercially available polyester polyol was used for examples 1 to 3 (comparative examples), while 100 g of the polyester polyol of the present invention was used for examples 4 to 6 (embodiment examples). The purpose of this setting is to prepare the polyurethane foam materials of all examples with similar (or nearly the same) mole numbers of the hydroxyl groups, so that the molar ratio of the isocyanate groups and the hydroxyl groups for each of examples 1 to 6 is 1:0.9 to 1:1.1. This ensures the polyurethane foam materials of the comparative examples and the embodiment examples to be synthesized under comparable (similar) conditions (for example, the crosslinking conditions).

For example, in the case where 100 g of isocyanate is used, approximately 72 (g)×390 (mg KOH/g)=28.08 g of potassium hydroxide (KOH) is needed to prepare the polyurethane foam materials of examples 1 to 3 (comparative examples), and approximately 100 (g)×280 (mg KOH/g)=28 g of potassium hydroxide (KOH) is needed to prepare the polyurethane foam materials of examples 4 to 6 (embodiment examples). The amounts of hydroxyl groups for all examples are thus almost the same.

Referring to the burning test result for example 4, a predetermined point of the flame-resistant polyurethane foam material of example 4, after exposure to a flame at 1000° C. for 30 minutes and moved away from the flame, became ignited but the ignited flame was extinct within 3.2 seconds (that is, the length of the continuous burning time was 3.2 seconds or less). Besides, only 10% of the flame-resistant polyurethane foam material was burned to ash. In comparison to the comparative examples (examples 1 to 3), even in the absence of a flame retardant, the flame-resistant polyurethane foam material of one embodiment (example 4) of the present invention displays better flame resistance than that of the comparative examples (examples 1 to 3) which include flame retardants.

Moreover, referring to examples 5 and 6, these flame-resistant polyurethane foam materials include various amounts of a flame retardant having a benzene structure. After a predetermined area of each of the flame-resistant polyurethane foam materials of examples 5 and 6 was exposed to a flame at 1000° C. for 30 minutes and then moved away from the flame, the continuous burning time decreased with increasing amounts of the flame retardant. Further, the proportion of the flame-resistant polyurethane foam material burned to ash also decreased with increasing amounts of the flame retardant, indicating that the flame resistance of the flame-resistant polyurethane foam material increases as the added amount of the flame retardant increases.

Preferably, in the absence of a flame retardant, a predetermined area of the flame-resistant polyurethane foam material according to one embodiment of the present invention burns for 3.2 seconds or less after exposure to a flame at 1000° C. for 30 minutes (that is, the ignited flame is extinct within 3.2 seconds), and only 10% or less of the flame-resistant polyurethane foam material is burned to ash.

More preferably, in the case where 7 phr of the flame retardant with a benzene structure is added (that is, 7 g of the flame retardant is added in 100 g of the polyester polyol), a predetermined area of the flame-resistant polyurethane foam material according to one embodiment of the present invention burns for 2 seconds or less after exposure to a flame at 1000° C. for 30 minutes (that is, the ignited flame is extinct within 2 seconds), and only 5% or less of the flame-resistant polyurethane foam material is burned to ash.

Most preferably, in the case where 15 phr of the flame retardant with a benzene structure is added (that is, 15 g of the flame retardant is added in 100 g of the polyester polyol), a predetermined area of the flame-resistant polyurethane foam material according to one embodiment of the present invention burns for 1.9 seconds or less after exposure to a flame at 1000° C. for 30 minutes (that is, being extinct within 1.9 seconds), and only 5% or less of the flame-resistant polyurethane foam material is burned to ash.

As described above, because the flame-resistant polyurethane foam material of the present invention uses a polyester polyol with a high content (35 to 70 wt %) of terephthalic acid structure as one of the raw materials for synthesizing polyurethane, the flame resistance thereof significantly improves. Further, in the case where a phosphate ester with a benzene structure is further added as a flame retardant, the flame resistance of the flame-resistant polyurethane foam material can be further improved.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A flame-resistant polyurethane foam material, comprising:
a polyurethane prepared by reacting an isocyanate with a polyester polyol,
wherein the isocyanate has two or more isocyanate groups; and
wherein the polyester polyol has two or more hydroxyl groups and has a terephthalic acid structure.

2. The flame-resistant polyurethane foam material according to claim 1, wherein the polyester polyol is prepared by a condensation polymerization reaction between terephthalic acid and a polyhydric alcohol.

3. The flame-resistant polyurethane foam material according to claim 1, wherein the isocyanate has 28 to 34 wt % of the isocyanate group.

4. The flame-resistant polyurethane foam material according to claim 1, wherein the polyester polyol has a hydroxyl value of 250 to 450 mg KOH/g.

5. The flame-resistant polyurethane foam material according to claim 1, wherein the polyester polyol has a molecular weight of 300 to 3000 g/mol.

6. The flame-resistant polyurethane foam material according to claim 1, wherein a molar ratio of the isocyanate group to the hydroxyl group is 1:0.9 to 1:1.1.

7. The flame-resistant polyurethane foam material according to claim 1, further comprising a flame retardant.

8. The flame-resistant polyurethane foam material according to claim 7, wherein the flame retardant is a phosphate ester with a benzene structure.

9. The flame-resistant polyurethane foam material according to claim 8, wherein the flame retardant is diphenyl phosphate or triphenyl phosphate.

10. The flame-resistant polyurethane foam material according to claim 7, wherein a mass ratio of the flame retardant to the polyester polyol is 3:100 to 20:100.

11. The flame-resistant polyurethane foam material according to claim 1, further comprising a foaming agent.

12. The flame-resistant polyurethane foam material according to claim 11, wherein the foaming agent is water or pentane.

13. The flame-resistant polyurethane foam material according to claim 1, further comprising a catalyst.

14. The flame-resistant polyurethane foam material according to claim 13, wherein the catalyst is a tertiary amine or an organometallic compound.

15. The flame-resistant polyurethane foam material according to claim 13, wherein the catalyst is dimethylethanolamine.

16. The flame-resistant polyurethane foam material according to claim 1, further comprising at least one additive selected from a surfactant, an ultraviolet absorber, a light stabilizer, a chain extender, a crosslinking agent, a colorant, and a filler.

17. The flame-resistant polyurethane foam material according to claim 1, wherein a predetermined area of the flame-resistant polyurethane foam material burns for 3.2 seconds or less after exposure to a flame at 1000° C. for 30 minutes.

18. The flame-resistant polyurethane foam material according to claim 1, wherein 10% or less of the flame-resistant polyurethane foam material is burned to ash after a predetermined area of the flame-resistant polyurethane foam material is exposed to a flame at 1000° C. for 30 minutes.

19. The flame-resistant polyurethane foam material according to claim 8, wherein a predetermined area of the flame-resistant polyurethane foam material burns for 2 seconds or less after exposure to a flame at 1000° C. for 30 minutes.

20. The flame-resistant polyurethane foam material according to claim 8, wherein 5% or less of the flame-resistant polyurethane foam material is burned to ash after a predetermined area of the flame-resistant polyurethane foam material is exposed to a flame at 1000° C. for 30 minutes.
